(19) United States
(12) Patent Application Publication
(10) Pub. No.: US 2014/0131646 A1
(43) Pub. Date: May 15, 2014

(54) Self-Braking Motor

(71) Applicant: Stage Technologies Ltd, London (GB)

(72) Inventor: Ewart Richardson, Hertfordshire (GB)

(21) Appl. No.: 14/079,726

(22) Filed: Nov. 14, 2013

(30) Foreign Application Priority Data
Nov. 14, 2012 (GB) 1220495.4

(51) Int. Cl. H02K 49/04; B66D 1/12; B66D 5/00

(52) U.S. Cl. CPC H02K 49/043; B66D 5/00; B66D 1/12
USPC 254/362; 310/105

(57) ABSTRACT

There is described a self-braking motor that comprises a stator, a plurality of permanent magnets and magnetic hysteresis material. The permanent magnets are disposed concentrically between the stator and the magnetic hysteresis material and an air gap is provided between the magnetic hysteresis material and the permanent magnets. The self-braking motor has a first configuration, where the magnetic hysteresis material rotates with the permanent magnets, and a second configuration, where the magnetic hysteresis material is restricted from rotating with the permanent magnets.

### BACKGROUND

This application claims priority to GB Patent Application No. 1220495.4 filed Nov. 14, 2012, the entire contents of which are incorporated herein by reference.

The present invention relates to a self-braking motor. In particular the invention relates to a permanent magnet motor with a hysteresis brake.

The invention is of particular use in any system where lifting and lowering of a load is required. For example, in a theatre setting, where lifting and lowering of scenery may be required.

Traditional systems for lowering and raising include rope systems, counterweight systems and manual/motorised winching systems.

In a rope system the cables/ropes attached to the flying bar are run over at least one pulley and the other end of the rope is manually pulled and then secured in position on a so called pinrail by tying off the rope around a belaying pin. As will be appreciated this system is very manually intensive. It will also be difficult to raise/lower the ropes at the same rate to ensure smooth movement of the flying bar. Furthermore, the weight of the equipment attached to the flying bars, e.g. scenery or lights, and of the flying bars themselves, is significant.

In a counterweight system the free end of the rope attached to the flying bar is itself attached to an arbor. Weights are placed on the arbor to balance the weight of the flying bar and the equipment attached thereto to reduce the effort needed to raise/lower the flying bar. In a single purchase system the amount of weight put on the arbor is the same as the weight of the flying bar and its attachments, but this means that to move the scenery from the raised position to the lowered position the arbor will need to move the entire height of the wall, because for 1 metre movement of the flying bar the arbor will also need to move 1 metre. In a double purchase system the arbor will only need to move 1 metre for a 2 metre movement of the flying bar and attachments, therefore reducing the space needed for the system. However, the weight placed on the arbor will need to be twice that of the flying bar and any attachments. This means that the people loading the arbor must typically handle large weights. Additionally this system is known to be complicated to use and maintain.

In motorised winch systems the various ropes can be controlled by a single operator and the loads that can be lifted safely are far greater than with manual systems. Winches can also be used in conjunction with counterweight systems (which of course would still necessitate the manual loading of the counterweight). Some problems with winch systems are that they can be noisy, sometimes complex and can need more maintenance than rope/counterweight systems.

It will also be appreciated that when using a motor to facilitate the raising and lowering of the flying bar the power transfer requirements for raising the flying bar, where gravity is opposed, are significantly different to the power transfer requirements when lowering the flying bar, where the system is working with gravity. In fact, it is often the case that when lowering, the motorised system turns into a generator and the control system needs the means to dissipate this energy, often via relatively complex electronic systems that dump this energy into large resistors in the form of heat or feed the energy back into the supply grid. It is also necessary to include a brake into the system to ensure that the movement of the scenery can be halted when desired.

There is often more than one winch system used in any production and to enable maximum flexibility for the scenery used it would be desirable to reduce the space required by the motor and braking system associated with each winch.

It would also be desirable to reduce the size envelope of the motor and braking system associated with a winch.

It would also be desirable to remove the requirement for complex electronic systems to dump the energy produced when lowering the load on a winch.

It would also be desirable to reduce the noise generated by winches when raising and lowering loads.

It would also be desirable to optimise the components needed for use with a winch system.

The present invention seeks to provide a self-braking motor that minimises noise and the need for energy dissipation, whilst providing smooth braking and reproducible control.

### SUMMARY

According to a first aspect of the present invention, there is provided a self-braking motor. The motor comprises a stator, a plurality of permanent magnets and magnetic hysteresis material, wherein the permanent magnets are disposed concentrically between the stator and the magnetic hysteresis material and where there is an air gap provided between the magnetic hysteresis material and the permanent magnets. The motor has a first configuration where the magnetic hysteresis material rotates with the permanent magnets and a second configuration where the magnetic hysteresis material is restricted from rotating with the permanent magnets.

Advantageously, the magnetic hysteresis material is substantially static in the second configuration. More advantageously, the motor comprises a static member and a means for coupling the magnetic hysteresis to the static member in the second configuration. Alternatively, the motor may comprise a sprag clutch which is coupled to the magnetic hysteresis material, the sprag clutch is configured to allow the magnetic hysteresis material to rotate with the permanent magnets in the first configuration and restrains the magnetic hysteresis material from rotating with the permanent magnets in the second configuration. These give alternative means of changing the state of the self braking motor from that of the first configuration to that of the second configuration.

Advantageously, the motor has the first configuration when rotating in a first direction and the second configuration when rotating in a second opposing direction.

Advantageously, the plurality of permanent magnets form a magnetic ring and/or the magnetic hysteresis material forms a ring.

According to a second aspect of the present invention, there is provided a winch for lifting and lowering loads. The winch comprises a self-braking motor as previously discussed and a drum assembly that is configured to be driven by the self-braking motor.

Advantageously, the self-braking motor is disposed concentrically within the drum assembly. Thus, the sized envelope of the motor and braking system associated with the winch is reduced, which is particularly advantageous when more than one winch system is being used.

According to a third aspect of the present invention, there is provided a method of operating a winch. The method includes the steps of providing a self-braking motor as previously disclosed, providing a drum assembly driven by the self-braking motor; rotating the drum by running the self-braking motor in it's first configuration; and braking the drum by running the self-braking motor in its second configuration.

Thus, this aspect of the invention reduces the components for operating a winch by providing a motor which is self-braking, rather than having to also provide additional brakes to operate upon the drum assembly.

Advantageously, the motor has the first configuration when rotating in a first direction and the second configuration when rotating in a second direction, the second direction opposing the first direction.

Thus, the motor has its first configuration in a lifting direction and the second direction in an opposing lowering direction.

Advantageously the method further comprises rotating the drum in the second direction by driving the permanent magnets through the torque produced by the magnetic hysteresis material. This means that in order to rotate the drum in both the lifting and the lowering directions the motor must be driven. This means that energy is not generated when the drum is rotating in its lowering direction and that therefore the requirement for complex electronic systems to dump the energy produced with previous systems, or to feed the energy back into the supply grid, has been removed.

Other preferred features of the present invention as set out in the appended claims.

### BRIEF DESCRIPTION OF THE DRAWINGS

Embodiments of the present invention will now be described by way of example with reference to the accompanying drawings in which:

FIG. 1 is a longitudinal cross-section through a winch system comprising a self-braking motor located within a drum assembly of a winch in accordance with an embodiment of the present invention;

FIG. 2 is a radial cross-section through the self-braking motor and drum assembly of the winch of FIG. 1; and

FIG. 3 is a perspective view of the winch of FIG. 1.

### DETAILED DESCRIPTION

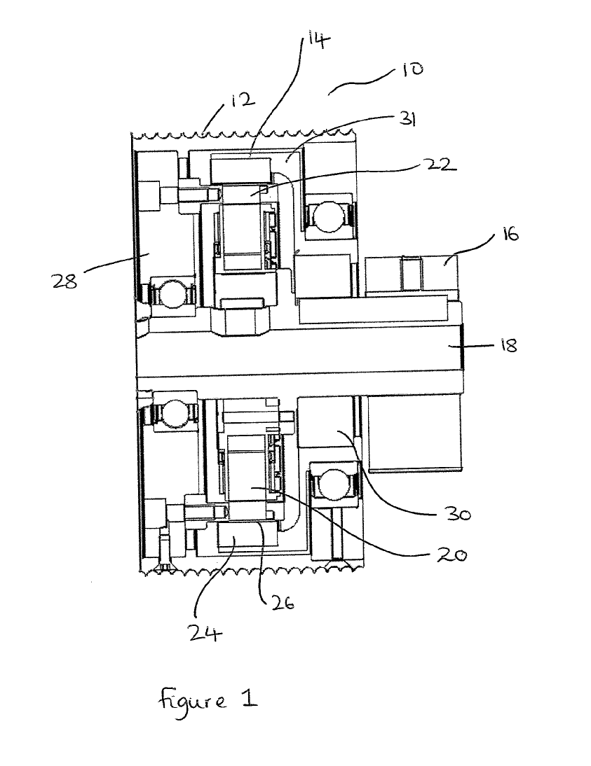

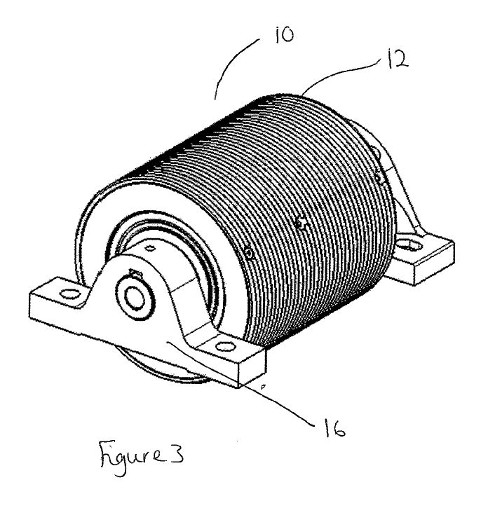

FIGS. 1 to 3 disclose a preferred embodiment of the invention.

FIG. 1 shows a winch 10. The winch 10 comprises a drum assembly 12 and a self-braking motor 14 and is attachable to a supporting structure (not shown) via an attachment mechanism 16. The self-braking motor 14 comprises a stator 20, a magnetic ring 22 and a ring of magnetic hysteresis material 24. An air gap 26 is provided between the magnetic ring 22 and the ring of magnetic hysteresis material 24. The magnetic ring 22 is coupled to the drum assembly 12 via a drive flange 28. The ring of magnetic hysteresis material 24 is coupled to sprag clutch 30. The sprag clutch 30 allows the ring of magnetic hysteresis material 24 to rotate with the magnetic ring 22 in one direction and restricts the ring of hysteresis material 24 from rotating with the magnetic ring 22 in the opposing direction.

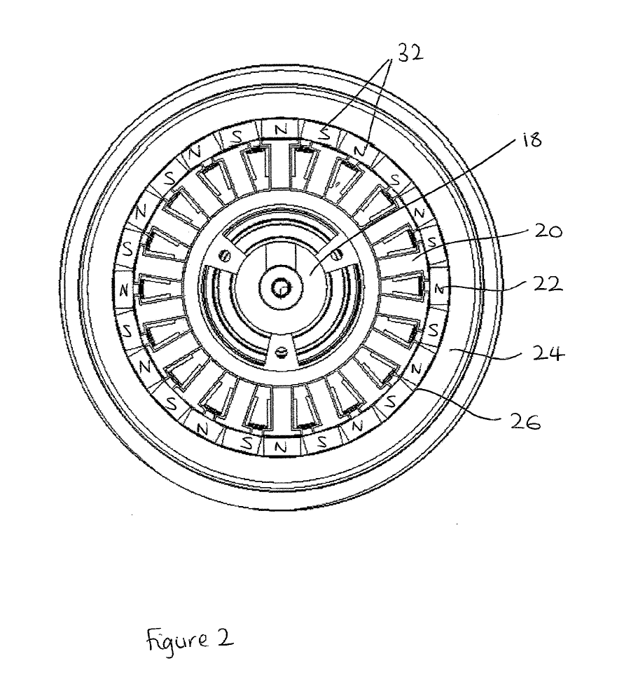

From FIG. 2 it can be seen that the magnetic ring 22 comprises a plurality of permanent magnets 32 that are regularly spaced around the ring. As is shown the magnets 32 of the magnetic ring 22 have alternating poles. Also shown is the ring of magnetic hysteresis material 24 and the stator 30, all being concentric with the magnetic ring 22. The air gap 26 is between the magnetic ring and the ring of magnetic hysteresis material.

The self-braking motor 14 and sprag clutch 30 are located within the drum assembly 12.

In operation, energy is supplied to the stator 20 and a rotating magnetic field is provided. The rotating magnetic field drags the magnetic ring 22 to rotate, thereby rotating the drum assembly 12. When rotating in the lifting direction the sprag clutch 30 allows the ring of magnetic hysteresis material 24 to rotate with the drum assembly 12. When the motor is energised to rotate in the lowering direction, the sprag clutch 30 restricts the ring of magnetic hysteresis material 24 from rotating, preferably holding it substantially still. The torque between the magnetic ring 22 and the ring of magnetic hysteresis material 24 brakes the magnetic ring 22 thereby preventing the drum assembly 12 rotating in the lowering direction. When lowering is desired the motor is driven sufficiently in the lowering direction to overcome the torque generated between the magnetic ring 22 and the ring of magnetic hysteresis material 24, thereby rotating the drum assembly 12 in the lowering direction. Due to the fact the motor must be driven in both the lifting and lowering directions there is no generation of energy that would then require dissipation.

In summary there are two configurations of the magnetic ring and ring of magnetic hysteresis material; the first configuration is where the ring of magnetic hysteresis material rotates with the magnetic ring and the second configuration is where the ring of magnetic hysteresis material is restricted from rotating with the permanent magnets.

It will be appreciated that the stator may be located outside of the magnetic ring, with the air gap and the ring of magnetic hysteresis material being located within the magnetic ring. What is important is that the permanent magnets are located between the stator and the hysteresis material.

It will further be appreciated that there are means other than the sprag clutch for restricting the rotation of the ring of magnetic hysteresis material. Examples include a pin arrangement that couples the ring of magnetic hysteresis material to a static component when the drum assembly attempts to rotate in the opposing direction, a toothed or keyed coupling or a keyless clamping arrangement. Similarly, it will be appreciated that the change between the two configurations, i.e. the change from a rotating motor to a braked one, may take place whilst the drum assembly attempts to continue to rotate in the same direction. In other words the hysteresis material may provide a braking mechanism to the drum assembly in the so-called lifting direction.

It will be appreciated that whilst the permanent magnets are shown forming a ring this is not essential to the invention. What is important is that an array of permanent magnets is arranged concentrically with the stator, with a sufficient number of permanent magnets to ensure rotation of the array of magnets when energy is supplied to the stator. Additionally, although twelve pairs of opposing permanent magnets are shown in the magnetic ring 22 other numbers are also possible for the array of permanent magnets. Similarly it will be understood that the hysteresis material need not form a ring. What is important is that there is hysteresis material arranged concentrically with the array of permanent magnets and producing a torque that will facilitate some braking force to the array of permanent magnets when the magnetic hysteresis material is restricted from motion.

It will be appreciated that, although the described embodiment discloses that a drum assembly is driven and braked by the motor of the present invention, it may equally be a drive shaft that is driven and braked by the self-braking motor of the present invention. Furthermore, the winch of the present invention can also be configured to be coupled to a drive shaft 18 and to thereby drive other mechanisms as required.

It will be appreciated that whilst the self-braking motor 12 and associated means for restricting the motion of the hysteresis material (in the specific embodiment the sprag clutch 30) are shown located within the drum assembly 14, they may also be located outside of an envelope defined by the drum assembly.

Although the described embodiment is for use with a theatre winch it will be appreciated that the self-braking motor of the present invention may find use in many other applications, such as winches for other operations and conveyor belts. These may move in two opposing directions, one of which is to be braked; or in one direction, the braking being applied in that one direction where desired by application of a mechanism, such as those described previously, to restrict the motion of the hysteresis material.

Although preferred embodiments of the invention have been described, it is to be understood that these are by way of example only and that various modifications may be contemplated within the scope of the appended claims.

1. A self-braking motor comprising:
a stator;
a plurality of permanent magnets; and
magnetic hysteresis material, wherein the permanent magnets are disposed concentrically between the stator and the magnetic hysteresis material and wherein there is an air gap between the magnetic hysteresis material and the permanent magnets;
the self-braking motor having a first configuration wherein the magnetic hysteresis material rotates with the permanent magnets and a second configuration wherein the magnetic hysteresis material is restricted from rotating with the permanent magnets.

2. The self-braking motor of claim 1, wherein the magnetic hysteresis material is substantially static in the second configuration.

3. The self-braking motor of claim 1 further comprising a static member and a means for coupling the magnetic hysteresis material to the static member in the second configuration.

4. The self-braking motor of claim 1, further comprising a sprag clutch coupled to the magnetic hysteresis material, the sprag clutch being configured to allow the magnetic hysteresis material to rotate with the permanent magnets in the first configuration and to restrain the magnetic hysteresis material from rotating with the permanent magnets in the second configuration.

5. The self-braking motor of claim 1, wherein the self-braking motor has the first configuration when rotating in a first direction and the second configuration when rotating in a second opposing direction.

6. A self-braking motor of claim 1, wherein the plurality of permanent magnets form a magnetic ring.

7. A self-braking motor of claim 1, wherein the magnetic hysteresis material forms a ring.

8. A winch for lifting and lowering loads comprising:
a self-braking motor as claimed in claim 1;
a drum assembly configured to be driven by the self-braking motor.

9. A winch as claimed in claim 8, wherein the self-braking motor is disposed concentrically within the drum assembly.

10. A method of operating a winch comprising:
providing a self-braking motor as claimed in claim 1;
providing a drum assembly driven by the self-braking motor;
rotating the drum assembly by running the self-braking motor in its first configuration; and
braking the drum by running the self-braking motor in its second configuration.

11. The method of claim 10, wherein the motor has the first configuration when rotating in a first direction and the second configuration when rotating in a second direction, the second direction opposing the first direction.

12. The method of claim 10 further comprising rotating the drum in the second direction by driving the permanent magnets through the torque produced by the magnetic hysteresis material.
